(19) United States
(12) Patent Application Publication
(10) Pub. No.: US 2007/0198629 A1
(43) Pub. Date: Aug. 23, 2007

(54) Scalable Content Based Event Multicast Platform

(75) Inventors: Samrat Ganguly, Monmouth Junction, NJ (US); Sudeept Bhatnagar, Plainsboro, NJ (US); Akhilesh Saxena, Plainsboro, NJ (US); Rauf Izmailov, Plainsboro, NJ (US); Yasuhiro Miyao, Kawasaki Kanagawa (JP)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/276,253

(22) Filed: Feb. 21, 2006

(51) Int. Cl. G06F 15/16

(52) U.S. Cl. 709/203

(57) ABSTRACT

In an infrastructure solution for content-based forwarding, filter pipelining enables handling of the high-rate message streams. Documents are distributed in the network by forwarding from publisher proxy servers to attribute trees associated with particular attributes in the message. The trees filter the messages based on attribute values, and deliver the messages to subscriber proxy servers for predicate-based distribution to subscribers. To maximize throughput, the attribute trees utilize the concept of weak filtering, wherein a message may be delivered to a node in the attribute tree that is associated with a range of attribute values that does not include the attribute value of the message.

### FIELD OF THE INVENTION

The present invention relates generally to content-based information dissemination and distributed publish-subscribe systems. More specifically, the invention is a system and technique for efficient and scalable content-based routing of messages to subscribers.

### BACKGROUND OF THE INVENTION

A content-based network forwards a message to all end-users who have registered subscriptions matching the content of the message. Both subscriptions and messages are represented in XML. Each subscription is a conjunction of ranges of values over multiple attributes. For example, a subscription represented as <STOCK=“xyz”, 5<=PRICE<=10> represents an interest in all messages having attribute STOCK with value “xyz” if they carry an attribute PRICE with a value between 5 and 10. All messages satisfying those values match the subscription and must be sent to the user. For a content-based network to scale to a high incoming message rate and large number of subscriptions, a fast filtering mechanism is mandatory.

One existing content-based networking architecture is SIENA, described in A. Carzaniga, M. Rutherford & A. Wolf, A Routing Scheme for Content-Based Networking; Proceedings of IEEE INFO COM (March 2004); A. Carzaniga & A. Wolf, Forwarding in a Content-Based Network Proceedings of ACM SIGCOMM (August 2003). An example 100 of a SIENA filtering structure is shown in FIG. 1A. SIENA's filtering data structure at each node 110 organizes all ranges of interest for all attributes for each subscription 120 in a sorted order. A value 130 corresponding to each attribute in a message is used to identify all subscriptions having interest in that value. That is done for all attributes carried in the message. If a subscription is interested in n attributes, then a message must reach that subscription through n different paths in the filtering data structure. Thus, counting the number of attributes of the message satisfying a subscription, SIENA identifies the matching subscriptions. SIENA replicates that functionality at all the nodes 110 in the network with the subscriptions at a node 140 comprising a cover of the subscriptions served by its children nodes.

The SIENA solution has several disadvantages. Each content-based router hosts a multi-attribute data structure to completely match the complex predicate for each subscription. The complete predicate matching cost, coupled with large space requirement to hold the data structure in memory or processor cache, increases the message processing latency. In a worst case scenario, each subscription is propagated to all nodes in the SIENA content-based network. The number of subscriptions to be matched in a single node in the SIENA solution can thus be very large, limiting the scalability of the system. Furthermore, as shown in the exemplary block diagram 160 of FIG. 1B, SIENA parses all messages and matches all attributes of a message with all subscriptions with an overlapping range at the same node. In the diagram 160, multiple nodes 165, 166, 167 parse the same message 170. That makes matching time per message in SIENA high, limiting that architecture's ability to support high-rate message streams.

In the recent past, a large body of work has emerged focusing on the problem of large scale selective dissemination of information to users. Several solutions were proposed based on using the multicast model. Using a conventional multicast model is not scalable as the number of multicast trees can grow up to 2ⁿ to capture all possible subscriber groups. The channelization problem formulated in M. Adler, Z. Ge, J. Kurose, D. Towsley, & S. Zabele, Channelization Problem in Large Scale Data Dissemination, IONP (2001) provides a solution to map sources and destinations to a limited set of multicast trees to minimize the unwanted message delivery. Another category of work, including A. Riabov, Z. Liu, J. Wolf, P. Yu, & L. Zhang, Clustering Algorithms for Content-Based Publication-Subscription Systems, Proc. of ICDCS (2002), creates a limited number of multicast trees by proper clustering of user subscription profiles. In the above solutions, filtering is done at the source, at the receiving point, or both. In contrast, other authors, such as those of M. Oliveira, J. Crowcroft, & C. Diot, Router Level Filtering on Receiver Interest Delivery, Proc. of 2nd Int'l Workshop on Networked Group Communication (2000), propose the use of filters in the intermediate nodes in a given multicast tree for selective data dissemination. R. Shah, R. Jain, & F. Anjum, Efficient Dissemination of Personalized Information Using Content-Based Multicast, Proc. of Infocom (2002) provides a solution to the filter placement and leak minimization problem. In multicast based approaches, the forwarding path of a message is restricted to pre-defined multicast tree topology. Although those approaches can apply well in topic/subject-based systems or messages with single attribute, they are not suitable for supporting general predicates over multiple attributes.

The added advantage of associating subscriptions to a multicast tree is marginal as the complex predicate must be finally matched either at source or receiver. Instead of restricting the model to a multicast model, a general model is to create a routing network composed of content-based routers, as proposed in the SIENA work and also in M. Aguilera, R. Strom, D. Sturman, M. Astley, & T. Chandra, Matching Events in a Content-Based Subscription System, Symposium on Principles of Distributed Computing (1999) (“GRYPHON”). A content-based router creates a forwarding table based on subscription profiles and performs both data filtering and forwarding based on predicate matching. As with any data distribution network, the speed of matching the subscription predicates at each content-based router determines the sustainable throughput. The goal of content-based routing is to provide processing latency meeting the wire speed.

In both SIENA and GRYPHON, each router may need to keep states about all subscriptions. Even though the SIENA authors propose subscription merging to minimize states, the resultant benefit is not applicable with subscription deletion.

A significant amount of research, such as that described in F. Fabret, H. A. Jacobsen, F. Llirbat, J. Pereira, K. A. Ross & D. Shasha, Filtering Algorithms and Implementation for Very Fast Publish/Subscribe Systems, ACM SIGMOD (2001), has been done on finding better solutions for general predicate matching at a single node. Such a centralized solution using a single node is unlikely to support the ever-increasing rate of information flow.

Reverse indexing structure to map content-space to subscriptions has been explored in T. Yan & H. Garcia-Molina, Index Structures for Selective Dissemination of Information under the Boolean Model, ACM Transactions on Database Systems (1994). Those authors also propose a variation of counting-based mechanisms to match predicates in a single node. However, to apply the counting method to a distributed system engenders new problems discussed below.

In certain solutions such as SIENA, the message dissemination path is coupled with the subscription movement path and therefore lacks the routing flexibilities. In contrast, other solutions such as P. J. Z. Ge, J. Kurose & D. Towsley, Min-Cost Matchmaker Problem in Distributed Publish/Subscribe Infrastructures, OPENSIG, (2002), are based on indirection and use rendezvous points in the form of broker nodes where messages meet subscribers.

Content-based information dissemination over a P2P network was proposed in XROUTE, described in R. Chand & P. Felber, A Scalable Protocol for Content-Based Routing in Overlay Networks, IEEE Symposium on Network Computing and Applications (2003). The main concern in that work is network bandwidth usage and minimizing the size of the routing tables.

The notion of weak filtering has been used in summary-based routing, such as in Y. Wang, L. Qiu, C. Verbowski, D. Achlioptas, G. Das & P. Larson, Summary-Based Routing for Content-Based Event Distribution Networks, IEEE Computer.

There is therefore presently a need to provide an infrastructure solution for content-based forwarding of high-rate message streams. To the inventors' knowledge, no such techniques are currently available.

### SUMMARY OF THE INVENTION

The scalable content-based event multicast platform of the present invention is an architecture for filtering and multicasting high-rate message streams while supporting a large number of end users. The present invention overcomes the above limitations by partitioning the filtering task into simpler components and distributing those components over multiple nodes. A message is partially filtered at a node and sent to downstream node(s) for further filtering. The pipelined filtering allows nodes to operate on different parts of different messages at the same time, thereby supporting high system throughput. That is because per-message processing delay in each node is reduced to match the message inter-arrival time. The presently described architecture partitions the task of matching different attributes to different filtering trees. The need to parse the message in the filtering trees is furthermore eliminated by attaching the value of an attribute as a label before sending the message to the appropriate filtering tree.

The architecture of the invention respects the resource constraints of each node in terms of bandwidth and memory, and assigns each node a filtering and forwarding load that is commensurate with its resources. That is done using a notion of weak filtering, whereby an optimal algorithm is designed to create the best filter at each node given its resource constraints. The present invention constructs a filtering tree for all attributes adaptively by adding new nodes only if the existing tree cannot handle the load. In order to meet the resource constraint, a subscription partitioning approach is also provided, in which both load (forwarding and processing) and state space are balanced at each node.

The present invention also provides the ability to tune the throughput of each node in the tree using selective subscriptions. In the base case, the presently described architecture subscribes to only one attribute for each subscription. If, at the last hop, a message is received corresponding to a subscription from one attribute tree, the message is parsed and all its attributes are matched with the interests of the subscription. In order to cut down the cost of parsing and thereby increase system throughput, the present invention uses a new technique whereby all nodes subscribe to more than one attribute of a subscription, and match a message only if its copies are received along all subscribed attributes. That selective subscription results in a reduction in the number of parsing operations and increases the system throughput.

In one embodiment of the present invention, a method is provided for distribution of a document in a network. A message is received at an attribute-based forwarding server. The message includes an attribute and an associated value. The message is forwarded to a root of a value-based forwarding tree, the tree corresponding to the attribute. From the root, the message is forwarded to at least one intermediate router of the value-based forwarding tree corresponding to a first range of values including the value associated with the attribute in the message. From the at least one intermediate router, the message is forwarded to a predicate-based forwarding server corresponding to a second range of values including the value associated with the attribute in the message, the second range being encompassed by the first range. At the predicate-based forwarding server, the message is matched to a user subscription and is forwarded to a user.

The method may also include the step of parsing the message at the attribute-based forwarding server to identify the attribute. In that case, a label may be attached to the message at the attribute-based forwarding server identifying the value associated with the attribute.

The label may be a pointer to a location of the value in the message. The label may further contain a unique message ID. The message may be an XML message.

The method may also include the step of, from the root or from one of the at least one intermediate routers, forwarding the message to an intermediate router corresponding to a third range of values that does not include the value associated with the attribute in the message.

The method may also include the step of dynamically adding an intermediate router between the root and the predicate-based forwarding server. The added intermediate router may reduce a number of messages forwarded to an intermediate router corresponding to a range of values that does not include a value associated with an attribute in the forwarded message.

The step of matching the message to a user subscription and forwarding the message to a user may further include the steps of determining a total number of attributes associated with the subscription, counting a number of instances of the message received at the predicate-based forwarding server, and matching the message to a user subscription when the number of received instances of the message equals the total number of attributes associated with the subscription.

The step of forwarding the message to a predicate-based forwarding server may further comprise the step of appending a label to the message including an identification of the forwarding tree.

Another embodiment of the invention is a method for accepting a subscription to receive messages in a content-based network. At a subscriber proxy server, a plurality of subscriptions is received, each subscription containing an attribute and a subscription range of values associated with the attribute. The subscriptions are aggregated by determining end points of non-overlapping ranges for the attribute, each non-overlapping range corresponding to a portion of at least one subscription, the end points corresponding to intersections of subscription ranges. The end points are forwarded to a root of an attribute tree corresponding to the attribute. At the root, minimum and maximum values of a union of the end points together with other end points from other subscriber proxy servers is determined. The minimum and maximum values are forwarded to a predicate-based forwarding server for determining which messages are to be sent to the root.

The method may further comprise the step of storing the attribute and the range of values at the predicate-based forwarding server.

The method may include the step of computing a set of non-overlapping filters for use in forwarding messages from the root to leaf nodes in the attribute tree. The step of computing non-overlapping filters may also comprise optimizing ranges of the filters to minimize a number of sent messages having an attribute value outside an attribute range of a receiving node.

Each subscription may contain a plurality of attributes and associated values, and the step of forwarding the end points to a root of an attribute tree is performed for less than all the attributes contained in the subscription. In that case, the method may further comprise the step of determining the attributes and associated values for which the forwarding step is to be performed, based on a degree of filtering benefit provided by the attribute.

The method may further comprise the step of dynamically adding an intermediate router between the root and the predicate-based forwarding server. In that case, the step of adding an intermediate router may result in a reduced a number of messages forwarded to an intermediate router that corresponds to a range of values that does not include a value associated with an attribute in the forwarded message.

### BRIEF DESCRIPTION OF THE DRAWINGS

FIG. 1A is a schematic diagram showing a prior art content-based routing architecture.

FIG. 1B is a block diagram showing an example flow through the architecture of FIG. 1A.

FIG. 2 is a schematic diagram showing a network architecture according to an embodiment of the present invention.

FIG. 3 is a block diagram showing a subscription process according to an embodiment of the present invention.

FIG. 4 is a block diagram showing a message flow according to an embodiment of the present invention.

FIG. 5 is a schematic diagram showing a tree structure according to an embodiment of the present invention.

FIG. 6A is a chart showing example multicast groups according to an embodiment of the present invention.

FIG. 6B is another chart showing example multicast groups according to an embodiment of the present invention.

FIG. 7 is a chart mapping multicast groups and filters according to an embodiment of the present invention.

FIG. 8 is a schematic diagram showing a tree structure according to an embodiment of the present invention.

FIG. 9 is a schematic diagram showing a subscription matching according to an embodiment of the present invention.

FIG. 10 is a plot showing processing time versus number of attributes in a system of the invention under stressful load.

FIG. 11 is a plot showing processing time versus number of attributes in a system of the invention under general conditions.

FIG. 12 is a plot showing throughput ratio versus message arrival rate in a system of the invention.

FIG. 13 is a plot showing per-message processing time versus number of subscriptions in a system of the invention.

FIG. 14 is a plot showing throughput ratio versus message arrival rate in a system of the invention with an increased number of subscriptions.

FIG. 15 is a plot showing percent maximum throughput achieved versus percent increase in incoming traffic for three time ratios in a system of the invention.

FIG. 16 is a plot showing percent maximum achievable throughput versus range width in a system of the invention.

FIG. 17 is a plot showing percent maximum throughput achieved versus percent increase in incoming traffic for three subscription widths in a system of the invention.

### DESCRIPTION OF THE INVENTION

Content-based networking is an emerging data routing paradigm where a message is forwarded based on its content rather than specific destination addresses that are attached to the messages. In that paradigm, data distribution to the users is based on the publish-subscribe model where publishers (sources) publish messages and subscribers (receivers) register their interest about the content. The content of each message has a list of attribute name and value pairs, such as (symbol=“google”; price=196.8). The subscriber interest is usually expressed as a selection predicate, such as (symbol=“google” & price>200 & volume>11M). A content-based network infrastructure enables selective data distribution from publishers to subscribers by matching the appropriate selection predicates.

Along with the rich functionalities provided by content-based network infrastructure, however, comes the high complexity of message processing derived from parsing each message and matching it against all subscriptions. The resulting message processing latency makes it difficult to support high message publishing rates from diverse sites targeted to a large number of subscribers. For example, NASDAQ real-time data feeds alone include up to 6000 messages per second in the pre-market hours; hundreds of thousands of users may subscribe to those data feeds.

The inventors have developed a scalable content-based event multicast platform capable of fast content-based data dissemination. The platform supports high streaming rates of messages. The specific objective of this work is to achieve a message processing latency that can match the message arrival rate while supporting rich content-based semantics. The main design philosophy is the efficient partitioning of the multi-attribute subscription matching tasks and the distribution of those tasks strategically among multiple servers, while respecting the resource constraints at each server. Fundamentally, the increased throughput of the presently described platform comes from the basic principles of pipelining, where the end-to-end throughput of the system increases by partitioning a task into smaller sub-tasks.

The message processing speed in a content-based router depends upon a variety of factors such as the subscription lookup data structure, the predicate matching algorithm, and the total space requirement. The presently described architecture differs from prior art systems by creating a distributed subscription-matching data structure over multiple nodes. Using that data structure, the architecture provides the following advantages to achieve fast message processing: a) it allows for control over the space and forwarding bandwidth requirement, b) it allows for each node to participate in partial matching of predicates in a distributed way towards global matching the complete subscription predicate, and c) it allows for staging the subscription matching process such that the processing complexity at each node can match the message arrival rate.

The architecture of the present invention comprises three stages of message forwarding to enable the filtering pipeline. Each stage is defined by a set of participating nodes and their well-defined roles. Those stages create an efficient system that maximizes filtering pipelining while meeting the state space constraints and bandwidth limitations. That results in the following advantageous features of the invention:

(1) A consistent distributed data structure for data filtering and forwarding, meeting the space requirements of a participating node.

(2) An efficient, attribute-specific tree construction for message filtering and forwarding that can adapt to content popularity distribution and subscription profile. Given the space requirements, an algorithm is provided for constructing an optimal filtering structure.

(3) Optimistic counting algorithm for fast matching of complete subscription predicate.

(4) Since task distribution also leads to an increase in the number of messages in the system, an approach is provided for adapting the task distribution based on content popularity and subscription interests.

(5) Label-based forwarding inside the network that limits costly message-parsing operations to the network edges.

Benchmark results from a real system implementation of the inventive architecture shows that it can sustain a throughput of more than 5,000 messages per second for 100,000 subscriptions with predicates of 10 attributes.

The Architecture

Data model: In the infrastructure of the invention, an event notification from a publisher is associated with a message m containing a list of tuples <type, attribute name(a), value(v)> in XML format where type refers to data type (eg., float, string). Each subscription u (also in XML format) from a user is expressed as a selection predicate in conjunctive form as u=P₁ ̂. . . ̂ Pₙ. Each element Pᵢ of u is expressed as <type; attribute name(a); value range(R)> where R: (xᵢ, yᵢ). Pᵢ is evaluated to be true only for a message containing <aᵢ, vᵢ> such that xᵢ≦vᵢ≦yᵢ. A message m matches a subscription u if all the corresponding predicates are evaluated to be true based on the content of m.

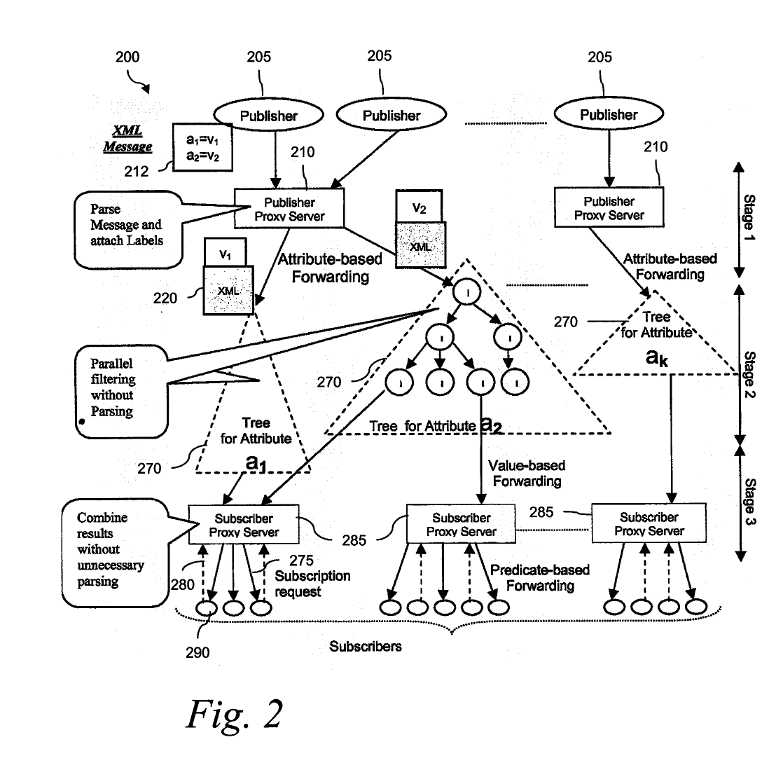

Overview: The presently-described architecture provides an infrastructure for fast content-based XML data distribution to interested subscribers by distributing the parsing, filtering and forwarding load among virtual nodes (servers). The general architecture 200 (FIG. 2) is based on a publish-subscribe service model. A publisher 205 contacts a Publisher Proxy Server (PPS) 210 to publish his data 212. Similarly, a user 290 contacts a Subscriber Proxy Server (SPS) 285 to send subscription requests 280 and to get notifications 275 matching its subscriptions. The choice of those servers 285 may be based on proximity or load. There is one filtering tree 270 corresponding to each attribute a. Any message 220 that contains a value for an attribute is routed over the attribute tree for a.

A PPS 210 sends a message 220 to roots of all attribute trees 270 corresponding the attributes contained in the message. The message is not sent to any other tree. Each attribute tree 270 performs range-based filtering using the value corresponding to its particular attribute. If no subscriber is interested in that value, the tree discards the message. Otherwise, the message is replicated and forwarded to all the SPSs 285 having a matching subscription. The SPS identifies all user subscriptions matching the message and forwards the message to them.

Conceptually, the PPS 210 performs filtering based on the attributes in the message (stage 1 of FIG. 2). An attribute's tree performs filtering on the values for that attribute in the message (stage 2). The predicate matching to identify all the subscriptions completely matching a message is done at the SPS (stage 3).

An overview is now provided of the subscription and message forwarding processes and the functionalities of each component are defined.

Subscription Process

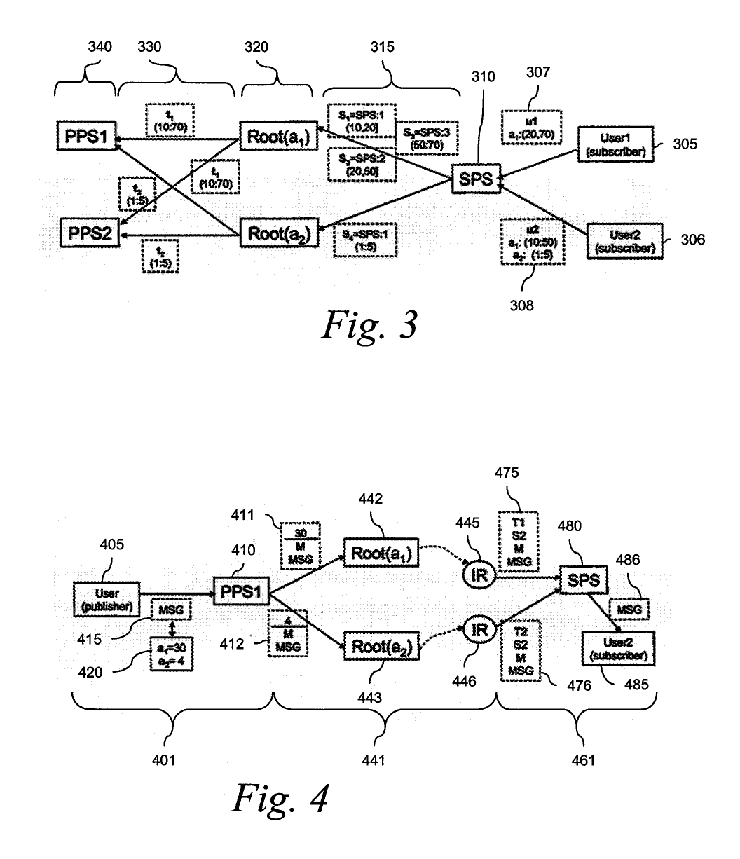

Referring to FIG. 3, a user such as users 305, 306 sends a subscription 307, 308 containing its ranges of interest over multiple attributes to an SPS 310. The SPS 310 stores the entire subscription locally. It then subscribes to different ranges of values for different attributes on behalf of the users 305, 306. The SPS 310 aggregates the individual user subscriptions u (e.g., u1, u2) into non-overlapping ranges 315 for each attribute. Consider a set Uₐ with all the user subscriptions u interested in attribute a. Each of those subscriptions is determined by a range (xᵢ, yᵢ) on attribute a. If there are n such subscriptions in Uₐ, their ranges can intersect at no more than 2n distinct points over the content space, and the number of distinct points could be lower if there are overlapping subscriptions.

For example, consider two subscriptions with ranges <20, 70> and <10, 50> for a given attribute. Those ranges intersect the content space at the distinct points (10, 20, 50, 70). Let the ranges be defined by two adjacent intersection points (l, m) in the ordered set of intersection points. For the above example, the ranges are (10, 20), (20, 50), (50, 70). For each of those ranges, SPS 310 creates a new subscription S and sends it to the corresponding attribute tree root 320. Note that this subscription aggregation process ensures that the SPS 310 subscribes to a value if and only if some user subscription is interested in it.

Each attribute tree root 320 receives the subscription S from one or more SPSs 310. The root finds the minimum and maximum value t: (xₘᵢₙ, yₘₐₓ) in the value space covered by the union of all ranges in S from all SPSs. The root informs the range t (element 330) to all the PPSs 340.

Message Filtering and Forwarding

An objective of the present invention is the efficient and correct delivery of messages to interested subscribers using content-based routing. In order to provide a high end-to-end throughput, the presently described architecture uses the concept of filter pipelining. A pipeline of well-designed components increases the end-to-end throughput. As noted above, the complex task of event filtering and routing is divided into three stages, shown in FIG. 2. Stage 1 is attribute-based forwarding, which is used for forwarding a message based on attribute name. Stage 2 is value-based forwarding, which is used for filtering the messages based on values of specific attributes, and forwarding them to the correct SPSs. Stage 3 is predicate-based forwarding, which is used for matching entire subscriptions based on the compound predicates, and notifying the users. The following is a general description of content-based routing according to the invention, with reference to the block diagram of FIG. 4.

Stage 1 (element 401) is attribute-based forwarding, which takes place at the PPS 410. Each publisher 405 is assigned an attribute-based forwarding server (PPS) 410. A publisher 405 sends a new message 415, containing multiple attribute-value pairs 420, to its PPS 410. The PPS 410 parses the incoming message 415 to identify its attribute names. Copies of the message are then forwarded to roots 442, 443 of all value-based forwarding trees Tᵢ corresponding to the attributes aᵢ present in the message. Before forwarding the message to Tᵢ, the PPS attaches the value Vᵢ of attribute aᵢ as a label (for example, labels 411, 412 of FIG. 4). As Vᵢ can be of any length, labels can be a pointer to the location of Vᵢ in the message. The PPS also attaches a unique message-ID M to the message. M is common to all copies of the message regardless of to which attribute trees they are forwarded.

Stage 2 (element 441) is value-based forwarding, which takes place at intermediate routers (IR) 445, 446. Upon receiving a message at the root 442, 443 of a value-based forwarding tree Tⱼ, the objective is to deliver that message to all SPSs 480 that have a subscription matching value Vⱼ. The value-based forwarding is implemented as a hierarchical forwarding tree structure using intermediate routers (IR) 445, 446 to provide two functionalities: message filtering and multicasting. Filtering restricts the multicast of a message to only those SPSs 480 that have at least one subscription matching the value Vⱼ contained in the message. In order to execute message filtering, each IR 445, 446 has a set of non-overlapping filters f_{a,b}. A filter f is defined by range (a, b) (where a, b ε content space V) and an associated set of nodes N.

A filter f allows only those messages m to pass through whose label value v lies in its range; i.e., v ε (a, b). A message that passes through f is forwarded to all the nodes in N. As shown in FIG. 5, each IR in the forwarding tree 510 has a list of filters, shown in tables 520. In an IR, a message is matched to a filter f using a range search on its label value v and then replicated and forwarded to the next hop nodes (IRs or SPSs) associated with f The forwarding tree 510 represents actions taken by the various IRs based on a value v=205. The construction of the value-based forwarding tree and the filters at each IR is based on the aggregated subscription profiles generated from each SPS. The IRs do not parse the message, as the entire operation uses the value v attached as a label.

Stage 3 (element 461 of FIG. 4) is predicate-based forwarding, which takes place at the SPS 480. Each SPS maintains a list of complete subscriptions sent by the users and hosts a predicate-based forwarding server for matching user subscriptions. Based on messages received from the value-based forwarding tree, SPS matches the compound predicates of the subscriptions. For each subscription match, the message is forwarded to the corresponding user. The SPS uses an optimistic counting algorithm to avoid parsing the message while determining the final recipients of each message it receives. The SPS also maintains an efficient data structure to minimize the number of subscriptions that are considered for matching.

In the example set forth in FIG. 4, a user 405 publishes a message 415 that has two attributes: a₁ and a₂, shown in box 420. The message is received at PPS1 410 and sent to the roots 442, 443 of the two attribute trees with corresponding labels 411, 412. The IRs 445, 446 forward those messages to the SPS 480 after adding labels 475, 476 identifying the tree, the SPS subscription S that matched the label, and the message ID. The SPS 480, upon receiving the messages, performs complete matching to user subscriptions and forwards the message 486 to the interested user (User2) 485.

Design Rationale

The architecture of the present invention is a resource-aware event distribution infrastructure for fast message filtering and dissemination. In order to provide high end-to-end throughput with low latency, the inventors have introduced the concept of filter pipelining. Any pipelined architecture strives to divide the task into smaller and faster components, each independent of the others, such that they collectively provide the desired end-to-end service. The pipeline achieves a higher throughput than a single component performing the entire task because the components can operate in parallel over different objects.

The entire filtering infrastructure enabling selective dissemination of messages to all interested users can be viewed as a single data structure over which a message traverses to reach the final destinations. Putting this data structure at a single node makes the node a bottleneck. The presently-described architecture recognizes that problem and builds a distributed data structure for filtering and assigns different portions to different nodes.

The invention exploits the pipelining principle while assigning components of the data structure to different nodes. As noted the entire filtering process is decomposed into three independent stages: attribute-based filtering, value-based filtering and predicate matching. That division of functionality among the various stages simplifies the task of building a fast filtering network. Two key benefits are reaped from pipelined filtering:

High end-to-end throughput: The different stages of the filtering pipeline operate in parallel on different tasks. Each of the stages perform simpler operations with lower processing time.

Individual stage optimization: By using independent stages to perform simpler and well-defined tasks, the performance of each stage is optimized separately. For example, the design requires that the IRs in an attribute tree, filter a message using only the value of the corresponding attribute. Thus, label-based forwarding avoids the expensive XML parsing operation inside the tree.

Another level of parallelism is achieved by having separate, value-based forwarding trees for each attribute. Messages are thereby filtered concurrently over multiple attributes, speeding up the filtering process. Having a single node apply multi-dimensional attribute based filtering over a message has a high time complexity, increasing as log(k)^{d} with d being the number of dimensions.

The design further allows optimization of the filtering at each node of the tree and the topology of the tree on a per-attribute basis. For example, a filtering mechanism for a string type attribute is different from a mechanism for afloat type attribute. For matching a string type attribute, one can use solutions such as SIFT, a mechanism particularly optimized for word based indexing and matching. The SIFT system is described in T. Yan and H. Garcia-Molina, The SIFT Information Dissemination System, ACM Transactions on Database Systems (1999).

Further, each attribute may exhibit a different pattern in terms of subscription profile and content space popularity distribution. That information can be used in optimal filter design for that attribute. By having a modular structure, new attributes can be added in the system by simply adding a new filtering tree. No reconfiguration of the existing routing structure is required.

The filtering architecture is hierarchical in nature. The key reason for that choice is that, in practice, the nodes are resource-constrained. The inventors have observed that the state space requirement at each IR increases significantly as the number of subscribers grows to several millions. At the same time, the multicasting forwarding load increases with the number of subscribers or with an increase in the message publication rate. If a node does not have enough memory, it cannot build the required filters to discard all messages that no SPS is interested in. Instead, the node can only construct weak filters (described later) that send some unwanted traffic downstream. To clean up that unwanted traffic, another downstream node must perform the filtering. Similarly, if a node does not have sufficient bandwidth, it cannot sustain a high forwarding rate to multiple SPSs. Thus, it needs a forwarding node to which it can off-load certain forwarding duties. Implicitly, in both cases, the helping nodes are acting as its children, leading to the notion of hierarchical filtering.

Value Based Forwarding

As discussed in the previous section, a PPS node receives a message from a publisher, parses it to determine the attributes it contains and sends it to the corresponding attribute trees. Before sending the message to tree Tₖ, it assigns a unique message-ID M, and a label containing the value Vₖ corresponding to the attribute aₖ. The value-based forwarding operation in the attribute tree is now detailed.

Each attribute tree contains subscriptions from multiple SPSs expressed as (SPSᵢ:Sⱼ). SPSᵢ is the unique-ID of the SPS which subscribed to the attribute. Sⱼ is the subscription ID that SPSᵢ assigned to the corresponding subscription range. SPSᵢ will assume that any message stamped with Sⱼ matches the corresponding subscription range. The goal of the attribute tree is to match the value Vₖ (in the label) in an incoming message to the subscriptions. Matching should ensure zero false positives; i.e, a message should be determined to be a match to a subscription if and only if the subscription range covers the value in the message.

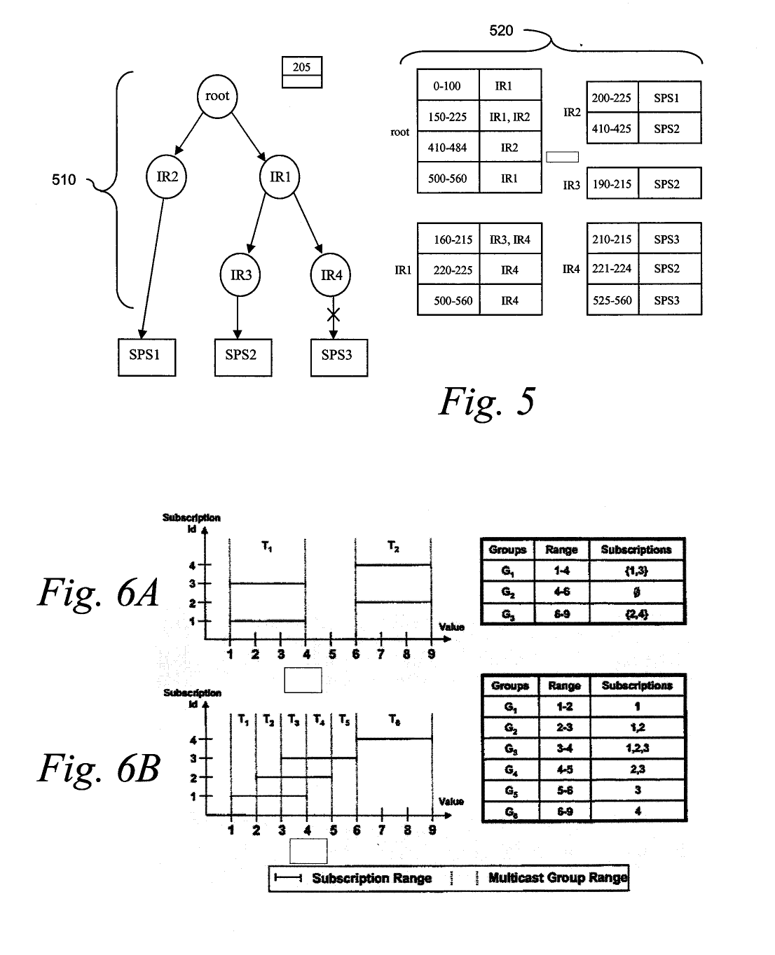

The set of subscription ranges arriving from different SPSs defines the portion of the content space that some users are interested in. Since each value can be of interest to multiple users (spread over different SPSs), it is natural to think of the value as being multicast to that set of users. From a given set of subscription ranges, the content value space can be partitioned into multicast group ranges denoted as Gᵢ. Each multicast group range is mapped into a set of subscriptions S such that any value in this range is covered by an intersection of ranges of all subscriptions in S. In the example shown in FIG. 6a, there are four subscriptions for ranges (1,4), (6,9), (1,4), and (6,9), respectively. Using the unique end-points of the subscriptions, the content-space is partitioned into three multicast group ranges: G₁ from 1-4, G₂ from 4-6, and G₃ from 6-9. Of those groups, there is no interested subscription in G₂ whereas G₁ and G₃ have two interested subscriptions each. Those multicast groups constitute the filters at that node.

As defined above, the forwarding structure at each node in the attribute tree consists of a set of non-overlapping filters. Each filter may be associated with one or more multicast group ranges. In order to ensure zero false positives, there is needed as many filters as the number of multicast group ranges (having some interested subscriptions), with each filter associated with one unique group. For example, in the illustration of FIG. 6A, two filters are required, one each for G₁ and G₃. That arrangement, however, raises the following two issues:

State space: Based on the subscription range distribution, the state space requirement of the forwarding structure can grow large enough to exceed the memory capacity. An example of state space growth is illustrated in FIG. 6b, which shows four subscriptions having a different subscription distribution that the four subscriptions of FIG. 6A. The different distribution results in six groups G₁ through G₆, requiring six filters. If the total state space requirement is considered as the cumulative number of group members over all groups, there are 10 units in FIG. 6B compared to 4 units in FIG. 6A, where each unit can be 1 byte. In fact, the real magnitude of the problem emerges from the analysis of a simple case: consider 100,000 subscriptions over a content space with values in the range 1-100,000. Subscription 1 is for range (1, 100,000), subscription 2 is for (2, 100,000) and so on such that subscription i is for (i, 100,000). All values from 1 to 100,000 form distinct end-points for the subscription sequence. Thus, there are 100,000 distinct groups with group Gᵢ having i associated members. The state space for this example is

$${\sum }_{i = 1}^{100 \text{,} 000} i = 5 \times {10}^{9}$$

entries. Even if a simple 4 bytes (integer) is assumed to store the subscription IDs (group members), that requires 20 GB of memory in the system. Furthermore, the state space explodes as n² for n subscriptions using the above example.

Forwarding load: Another problem created by the subscription distribution is that of forwarding load explosion. Suppose the arrival rate of messages with the value i in the example shown in FIG. 6A is i messages per second. Then the total forwarding load at the node in FIG. 6A to all the subscriptions is given by (1+2+3+4) messages per second to each of subscription IDs {1,3}, and (6+7+8+9) messages per second to each of subscription IDs {2,4}, resulting in 80 messages per second. However, for the subscription distribution shown in FIG. 6B, the total load is only 72 messages per second. Thus, while the state space requirement is higher in the example of FIG. 6B, the forwarding load is higher in the example of FIG. 6A. To get a better idea of the possible magnitude of forwarding load explosion, if there is an incoming message rate of 1 byte per second per value in the above example, the resulting outgoing rate will be 5 GB/s.

One objective of the present invention is to construct a hierarchical filtering structure by distributing both the forwarding space and load among multiple nodes. The construction is adaptive to the message value popularity distribution and subscription range distribution over the content space.

In order to capture the popularity distribution of different values, each node keeps aggregate arrival statistics for different values in the form of a histogram. The histogram provides the distribution of values in a given unit interval over the entire content space. The histogram is updated using a sliding window average every time a message is received. From the histogram, one can easily compute for any range r in the value space, the fraction of traffic p(r) with values in r. Note that the total traffic with values in range r is λp(r) where λ is the total message arrival rate.

Space and Load Partitioning

If the root node of the attribute tree cannot handle the space and forwarding load requirements, the filtering and forwarding task is distributed among multiple children. The inventors have observed that both the number of multicast group ranges and the associated forwarding load are increasing functions of the number of subscriptions. Thus, by partitioning the subscriptions among multiple children, it is possible to meet both space and forwarding constraints of each node. Each node can then serve a subset of all subscriptions by having a unique filter for each multicast group range, thereby ensuring zero false positive delivery to the SPSs.

It is assumed that the available space and forwarding bandwidth for each node in a resource pool is given. Assume, in the current state, that the set of all subscriptions is partitioned among k nodes, all of which are children of the root. The subscription set in the node i denoted as Sᵢ. The following subscription partition process is used when a new subscription request S is received at the root.

Subscription partition and movement: Consider a node i with a maximum forwarding capacity of c(Sᵢ) and suppose that l(Sᵢ) of its capacity is currently being used to forward messages to downstream nodes. l(Sᵢ) is the forwarding load of node i. If the subscription S is assigned to node i, the increase in its forwarding load is δ_{S}^{l}=p(r)λ where r is the range of values subscribed in S. The above is true as each subscription identifies a unique SPS because of the user subscriptions being aggregated at the SPS. One can now easily find the feasible set of nodes N for which l(Sᵢ)+δ_{S}^{l}≦c(Sᵢ). Let g be the total number of multicast groups for a node j in N with subscription set Sⱼ. If S is assigned to node j, the total space requirement will increase by maximum δ_{S}^{g}=g′+2 where g′ is the total number of multicast group ranges spanned by the range of S. In order to minimize the increase in space requirement, S is assigned to node j for which δ_{S}^{g}(j) is minimum. If the space requirement is not met by any of the nodes in N, however, a new node is added to which the subscription is assigned. Note that the solution does not provide for load balancing; instead it tries to minimize the number of nodes while meeting their capacity constraints.

Hierarchical Filtering

In order to have the filtering at each of the k leaf nodes, the root can forward each message to all of those nodes. Simple forwarding, however, leads to the following problems: a) the total outgoing message forwarding load λk at the root becomes high; b) the number of messages processed by each leaf node is high (the number of messages received is independent of the subscriptions handled by the leaf node) and c) increased overall network traffic. It is therefore worthwhile for the root to invest in the filtering process, albeit in a weak form meeting the space constraint. In order to clarify weak filtering, a “leak” is defined herein as follows: an amount of extra traffic that is passed to a node with subscription set S which is not matched by S and thus the node should not have received it.

A leak occurs where there is a partial overlap between a filter range and an associated multicast group range. Let us define G(f) as a set of multicast group ranges covered by f. Let the subset of group ranges in G(f) that is of interest to subscriptions in the leaf node i be G(i). It follows that any message passed by f intended for multicast group ranges G(f)−G(i) contributes to the traffic leak for node i.

Definition: The leak of a filter f (denoted as L^{f}) is defined as the total traffic leak caused by f given as

$${L}^{f} = {\sum }_{i = 1}^{k} p ( 𝒢 ( f ) - 𝒢 ( i ) ) λ$$

where p(G(f)−G(i)) is the fraction of traffic with values in the partition ranges G(f) and not in G(i) as obtained from the histogram. A filter f with a non-zero leak L^{f} is called a weak filter.

The example mapping shown in FIG. 7 illustrates a leak from filters 710 for a given set of subscriptions 715. In the example, it is assumed that each unit value interval (i:i+1) has traffic of 1 message/second. In order to find the leak from f₁, consider leaf nodes 1 and 2 in filter tree 720. Suppose that node 1 hosts subscriptions 1 & 2 with ranges (1-4) and (3-6), respectively. Further suppose that node 2 hosts subscriptions 3 & 4 with ranges (3-5) and (6-9). As shown in FIG. 7, partitioning those ranges results in 5 multicast groups G₁, . . . , G₅. We obtain G(f₁)={G₁, G₂, G₃}, G(node 1)={G₁, G₂, G₃}, G(node 2)={G₂, G₃}. Therefore, the leak for node 1 from f is zero as G(f₁)−G(node 1)=0 while leak for node 2 from f is 2 messages/second as G(f₁)−G(node 2)={G₁}.

Computing the same for filter f₂, we obtain the total leak from both filter f₁ and f₂ to be 7 messages/second. The interesting point to note is that without any filter (equivalent to having one filter), the total leak is 7 messages/second as well. However, with filters f₃ and f₄, the total leak is reduced to 3 messages/second. It can be concluded that creating proper filters is important in order to exploit the benefit of filtering at the root. Next is presented an optimal polynomial time algorithm for filter construction.

Optimal Filter Construction

Given the set of subscriptions and their location in one of the leaf nodes, this method constructs k nonoverlapping filters such that

1) They span the subscription space; i.e., any value that any subscription has subscribed to, must pass through one of the filters; and

2) The combined leak of the entire filter set F is minimized; i.e.,

$${\sum }_{i = 1}^{k} {L}^{{f}_{i}}$$

is minimized.

A dynamic programming method is now presented for the above problem. The method runs for k−1 iterations where k is the number of filters to be constructed. In the i^{th} iteration, the method computes the best filter set if there were allowed only i+1 filters (denoted by L(Fᵢ₊₁). That is done using the filter sets generated in the i−1^{th} iteration and strategically adding a new filter. The total leak of a filter set Fᵢ; is denoted by L(Fᵢ).

A key property of a filter's leak as defined above is that it is self-contained and independent; i.e, the total leak due to a filter f is computed using only the portions of subscriptions that overlap it and the value of the leak remains the same regarless of how the remaining filters are designed (recall that the ranges of filters are non-overlapping).

Let v₁ . . . vₙ denote the distinct edge points in the value space in increasing order corresponding to either start or end of a multicast group ranges G. In order to take advantage of the bookkeeping capability of dynamic programming, some partial information is stored after each iteration. That information is in form of a filter set over a subset Vᵢ of edge points where Vₖ={vₖ . . . vₙ}. Fᵢ^{j}(Vₖ) denotes the filter set defined over Vₖ when there are i filters such that the first filter spans vₖ, . . . , vₖ₊ⱼ and the remaining i−1 filters are spread over the range vₖ₊ⱼ₊₁, . . . , vₙ. Note that, if n−j−k>i−1 then the set Fᵢ^{j} is meaningless since there are not enough values to assign the i−1 non-overlapping filters over that range. Let Fᵢ*(Vₖ) define the optimal filter set of i filters over Vₖ such that total leak L(Fᵢ*(Vₖ)) is minimized.

The base step of the method involves computing the filter sets assuming that there are two filters. The only case where only one filter covering the entire range suffices is when there is only one subscription. Clearly, with two or more distinct subscriptions, two or more filters will have a lower total leakage than a single filter. To compute the filter sets assuming that there are two filters, all the sets F₂¹ (Vₖ) to F₂ⁿ(Vₖ) and the corresponding leakage L(F₂^{j}(Vₖ)) are computed. F₂*(Vₖ) is obtained as minⱼ(L(F₂^{j}(Vₖ))).

The subsequent iterations i in which the filter sets with i filters are found, utilize the sets Fᵢ₋₁*(V₁) . . . Fᵢ₋₁*(Vₙ) instead of combinatorially testing all possible filter assignments with i filters. As mentioned above, that is possible due to the independence of the filter leaks with respect to other filter leaks. Thus, to compute the best filter set Fᵢ*(Vₖ), the already-computed filter sets Fᵢ₋₁*(Vⱼ) are utilized for all j in previous iterations. Since the total leak of Fⱼ₊₁ⁱ⁻¹ does not change regardless of how (or how many) the filters are distributed over range 1 to j, and Fᵢ₋₁*(Vₖ) has the minimum leak over that range, it follows that the optimal Fᵢ* is given by f_{1,j}∪Fᵢ₋₁*(Vⱼ₊₁), where f_{1,j} is a filter spanning v₁:vⱼ.

That operation is continued until a filter set F₁^{k} is obtained having the optimum value of total leak given k filters.

Multi-Stage Filtering

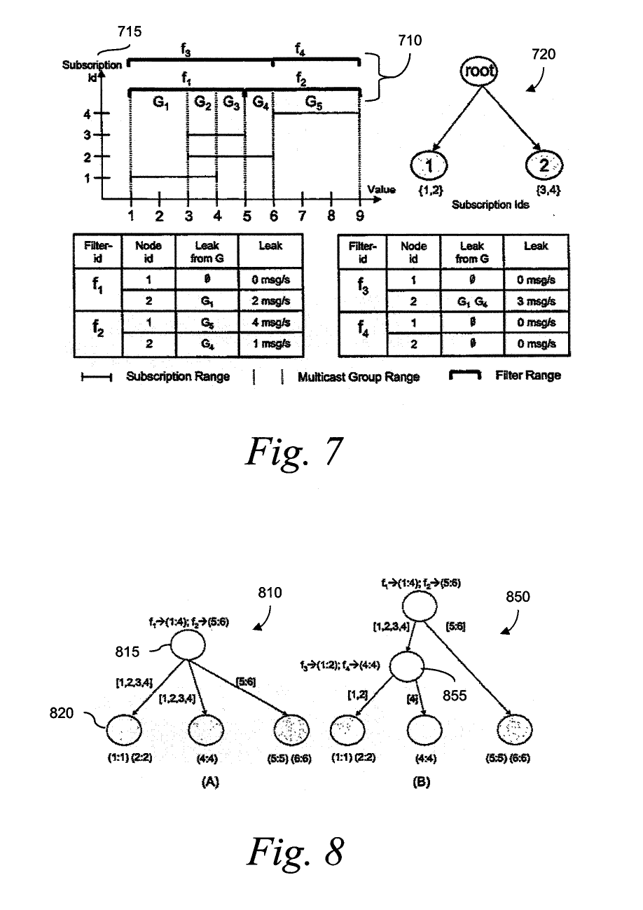

Although the above solution minimizes the leak at the root, it does not completely eliminate it subject to the space constraints. One can add multiple layers between the root and the leaf nodes to successively filter messages leading to zero leak. For example, the filter tree 810 of FIG. 8 has leakage from the root node 815 to node 820. An additional node 855 has been added to tree 850, eliminating the leakage.

In such a multi-stage arrangement, the total event space is partitioned and each partition is assigned to a given node in that stage. Partitioning is done such that each partition has an equal number of multicast group ranges. The number of partitions is determined by the amount of leakage from the previous stage. The inventors have determined that under most scenarios a single stage framework is sufficient to handle the leaks.

Predicate Based Forwarding at SPS

Each SPS contains various user subscriptions and is responsible for subscribing to appropriate attribute trees on behalf of those subscriptions. Based on the incoming messages, SPS performs predicate matching and forwards the message to users with matching subscriptions. However, matching the content of a single message against all the subscriptions is inefficient. Furthermore, each end-user subscription predicate is multidimensional, whereas the received message only corresponds to one dimension. Below is presented an optimistic counting algorithm. The algorithm is a predicate evaluation mechanism based on efficient data structure that achieves fast subscription matching.

Optimistic Counting Algorithm

Consider a single user subscription s with a selection predicate defined on n attributes. Assume that the SPS subscribes to all n attribute trees on behalf of the user subscription. If the SPS receives n copies of a message corresponding to each attribute tree, it implies that the user subscription is evaluated to be true. Any fewer than n copies would mean otherwise. Therefore, it is possible to establish whether a subscription is matched by simple counting. In essence, the algorithm recognizes that the messages reaching an SPS are already filtered along different attribute trees, and tries to avoid further local matching. That simple observation serves as the basis for the optimistic counting algorithm.

The algorithm is considered optimistic because it assumes that all copies of the messages are definitely going to arrive if they are going to match the subscription. The algorithm further assumes that all copies of the messages will arrive in a reasonably finite time.

In order for the above algorithm to be of practical use, there are several problems that must be addressed: 1) each subscription S of an SPS for a given attribute tree is a union of several user subscriptions s for that attribute. Therefore, in order to take any action for a message m, SPS must know from which attribute tree it arrives, and who the user subscriptions are, without parsing the message content; 2) messages m can come asynchronously from different attribute trees; 3) the messages can be arbitrarily delayed, so the SPS must maintain the counts of multiple subscriptions for some duration; and 4) subscribing to multiple attributes for a subscription can result in extra overhead because of the multiple copies of the message received, thus a mechanism is required to curtail the number of attributes for which the SPS should subscribe.

Forwarding Structure at SPS

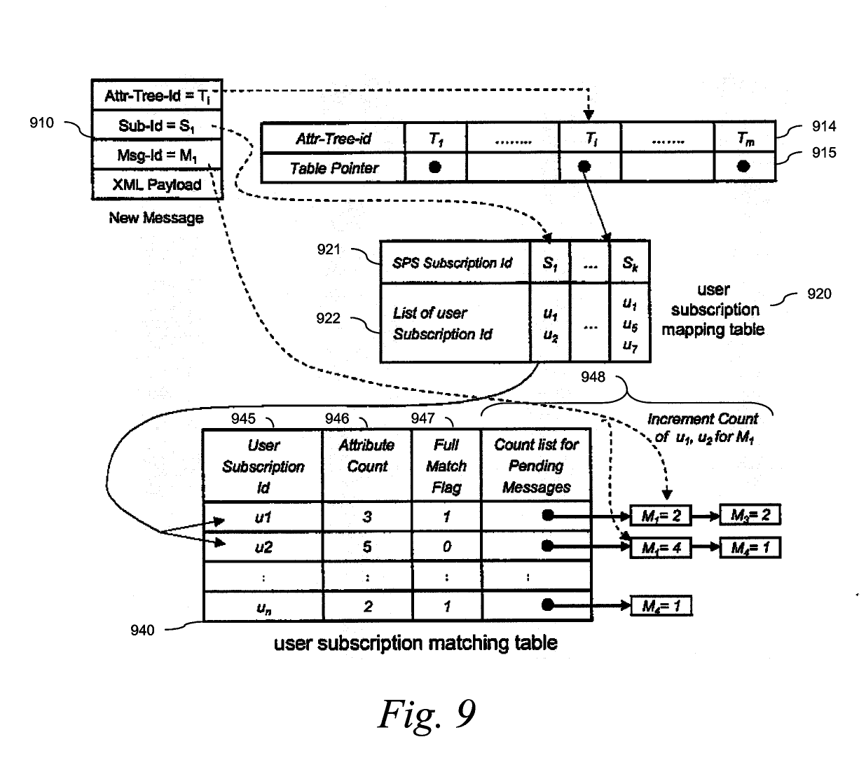

The forwarding mechanism 900 at the SPS, shown in FIG. 9, is now described with respect to the action taken on a given message and the corresponding data structures used. When a message 910 arrives at the SPS, the SPS identifies the attribute tree ID T and the subscription ID S. That information is added to the message 910 as a label from the last hop node in the attribute tree.

More specifically, from the tree ID Tᵢ 914, the corresponding user subscription mapping table 920 is accessed via a table pointer 915. There is one table 920 for each attribute tree wherein each column contains a subscription ID Sᵢ used by the SPS to subscribe to the attribute tree. Using that table 920 one can map the subscription ID Sᵢ (row 921) in the message 910 to a list of constituent user subscription IDs s (row 922). Thus two lookup operations yield the user subscription list containing user subscriptions interested in the message 910. In the example of FIG. 9, those user subscriptions are u₁ and u₂.

SPS also maintains a subscription matching table 940 indexed by the unique ID 945 of the user subscription uⱼ. For each subscription, the attribute count field 946 contains the number of attributes for the subscription for which the SPS has a corresponding subscription. The full match flag 947 indicates whether the attribute count represents the actual number of attributes of the subscription. A value of 1 in this field indicates that the SPS has subscribed to all attribute trees for this subscription indicating that getting the required number of copies of a message would mean a complete match, whereas in the case of a 0 value it would indicate only a partial match. The table 940 contains a hash-queue 948 of pending message IDs and their counts. The hash queue 948 contains a list of all messages that have matched along some (but not all) attributes; those messages are indicated by having a count greater than zero but less than the attribute count. Merely counting the number of copies of a message received is not enough to match user subscriptions; only messages arriving from specific trees should increment the count for a specific subscription.

Lastly, the SPS maintains a complete table of all user subscriptions with a required count for a message to match the subscription. Along with each subscription a list of currently partially matched message-ids is maintained along with the count of the number of copies of the message received.

In the user subscription matching table 940, for message 910, the list of pending messages for u₁, u₂ is traversed. Using the unique message ID Mₗ of the message, it checks if the message is already pending. It increments the count for M₁ in both u₁ and u₂. Since the count of M₁ for u₁ now goes to 3, it is a complete match as the full match flag 947 is 1 and the message is sent directly to u₁. Also, the count for M₁ for u₂ reaches 5, which is the required attribute count 946, implying that M₁ matches u₂. However, this is a partial match since the full match flag for u₂ is 0 indicating that there are more than 5 attributes in u₂. In that case, the message is now sent to the message cache (described next) to be matched completely against the content of M₁.

Message Cache and Timer Management

An SPS can receive multiple copies of a message with each arrival, possibly resulting in some partial matches. Without any special mechanism, that would require parsing the message each time to test for a complete match. Since parsing is a costly operation, that overhead is partially alleviated using a message cache. Whenever a new message arrives, it is added to the message cache. Any subsequent copies of the message are used only for the counting algorithm. Furthermore, the message is parsed lazily; i.e, only when the first partial match occurs. If all the subscriptions that matched the message are fully subscribed (i.e., full match flag is 1 for all its interested subscriptions), then the message would not be parsed at all.

A feasible implementation of the message cache requires the use of timers. There are two uses of timers in the system of the present invention. A timeout for a message in a subscription's pending queue indicates that the message did not match and the entry can be discarded. A timeout in the message cache indicates that a duplicate copy of the message is no longer expected and the message can be purged from the cache. Both timer expiry durations depend upon the maximum possible delay between different attribute trees. In practical scenarios that delay would be small.

In one embodiment of the invention, the SPS starts one or more timers whenever it gets a new message. In that case, however, the number of active timers may quickly grow into an infeasible number. In a preferred embodiment, that overhead is controlled by grouping the expiry events into buckets and using a timer expiry to process all events in the corresponding bucket.

Selective Subscriptions

In order to alleviate the problems caused by the requirement that the SPS subscribe to all attributes for each subscription, the presently disclosed architecture allows the SPS to subscribe to only a subset of attributes for each subscription. The rationale for this choice is that certain attributes and values would be very common (especially in skewed distributions) vis-a-vis the others. Thus, by subscribing to a popular attribute, the SPS does not gain much in terms of filtering. For example, if a user subscribes to the entire content space for a particular attribute, then all messages for that attribute would match the subscription. In that case, that attribute is not helping the filtering process at all. In such a case, the SPS decides to subscribe to an extra attribute only if it gets significant benefit with respect to the filtered traffic. Specifically, the selectivity of a subscription range determines whether the SPS subscribes to it or not.

While selectivity reduces extraneous traffic by curtailing the number of attributes an SPS subscribes to, it introduces a new problem: now even a message that matches a subscription completely cannot be identified by merely counting. The reason is that the count can only ensure that the subscription matches in all attributes that were subscribed to. There is no way of determining whether the remaining attributes match or not without looking at the message content. Thus, the message must now be parsed and matched at the SPS.

Since the above relaxed algorithm no longer allows for exact matching, it is natural to question its utility. The key benefit that the relaxed algorithm still provides is identifying the non-matching subscriptions. If k attributes of a subscription have been subscribed to and the SPS receives at most k−1 copies of the message from the corresponding trees, then regardless of the values of its remaining attributes, the message does not match the subscription. That drastically reduces the number of subscriptions that must be matched against a message.

Choosing Subscription Ranges

The selective subscription mechanism of the presently described architecture requires a technique to determine the ranges for each attribute to subscribe to. Below is presented a simple strategy to solve that problem using the event arrival statistics, and the cost of matching and counter-incrementing operations.

The SPS comprises two separate units: 1) a matching unit that identifies the matching subscriptions for each message, and 2) a forwarding unit, that forwards the message to all matching users. Clearly, if the forwarding unit cannot handle the forwarding load, it is necessary to move some subscriptions to other SPSs, as the forwarding load consists entirely of desired messages. Hence, for this discussion, the matching unit is considered.

Intuitively, adding an extra subscription is useful only if it increases the system throughput. Thus, if M distinct messages arrive at the SPS per unit time, then the SPS becomes a bottleneck if it matches fewer than M messages per unit time. Here matching a message refers to the message being sent to the forwarding unit along with all matched subscriptions. Using selective subscriptions, the throughput of the matching unit can be increased.

Suppose that we have n attributes a₁, a₂, . . . , aₙ. Let the arrival rate for value range rᵢ for attribute aⱼ be λᵢⱼ. Let the average time taken to fully match a message against a subscription be t_{f} and the time taken to increment a message counter be t_{c}. t_{f} is expected to be much higher than t_{c} because a full-match involves parsing the message and matching all its attributes against all attributes in the subscription. The expected time T to process a message by the SPS is given by n₁*t_{f}+n₂*t_{c} where n₁ is the number of full matches by the SPS and n₂ is the number of counters incremented by the SPS. If T is less than 1/M then the SPS is not the bottleneck. Otherwise, T must be reduced by subscribing to additional dimensions for some subscriptions.

Any subscription s is initially subscribed to only one of its attributes aₛ (the attribute with least arrival rate over its subscription range R(aₛ)). Thus, any message matching R(aₛ) will increment the counter for s and if s has range constraints over multiple attributes, it would have to be fully matched. In that case s contributes towards both n₁ and n₂. By subscribing to an additional attribute a′^{s} for s, we reduce the expected full-match cost because now s needs to be fully matched only when an additional attribute has already matched in the counting domain. In fact, if by subscribing to a′ₛ, all attributes of s have been subscribed to, then it will never have to be fully matched.

An additional subscription, however, increases the incoming message rate. The additional subscription does not increase the number of messages that must be fully matched, since those messages have already arrived from the existing subscriptions. The full-matching cost therefore never increases with additional subscriptions. The time for counter increment, however, increases because the additional subscription could result in extra messages that may increment several counters themselves. Hence, there exists an optimal point beyond which the throughput of the matching unit starts decreasing when we subscribe to extra attributes. The decision of the SPS in subscribing to additional attributes is aimed at operating at that optimal level which can be reached by an incremental algorithm: the SPS calculates the effective throughput if it subscribes to a range with the least extra traffic. If the effective throughput increases, it subscribes and checks the next candidate range; otherwise it stops. In the evaluation section below, it is shown that that simple strategy can significantly increase the throughput of the matching unit under different circumstances.

Evaluation

The effectiveness of the presently-described architecture has been demonstrated by running several experiments over a prototype implementation and some simulations. The inventors use zipf distribution to generate both the subscriptions and messages so that the value i occurs with probability i^{-α} (normalized by number of values) where α is the zipf parameter. To generate the subscription ranges, a number is drawn from the zipf distribution as the lower end of the subscription range. Since lower values of the values space are more prevalent in the zipf generation, those values are permuted using a random permutation vector so as to disperse the popular values in the distribution. The higher end of the subscription is generated using a uniform width with a specified mean (that is varied in the experiments). Since a subscription exhibits interest in all values within its range, that technique allows having more subscriptions concentrated around the more popular values. Furthermore, using subscription width as a parameter allows control of the overlap between multiple subscriptions, giving a wider test area.

For the evaluation purposes, the following definitions are set forth:

Definition: The per-message processing time of a node is the mean time it takes for the node to identify all the subscriptions that completely match a message.

Definition: The throughput ratio of a node is the ratio of the mean message inter-arrival time the node sees and the per-message processing time of the node. A throughput ratio of less than 1 is a must for a node to be able to seamlessly filter and forward an incoming message stream.

Implementation

The inventors have implemented a system prototype using the optimal filters at IRs (defined above) and the optimistic counting algorithm at the SPS. Below are presented some performance results taken over a cluster of nodes. The key performance metric is the effective throughput of the matching unit of an SPS. That performance metric of interest was chosen for two reasons: 1) the filtering cost at IRs is much lower compared to the SPS because the match is on a single attribute for aggregate subscriptions; and 2) the actual throughput of the SPS depends on the subscriptions and the message arrival rate. Hence the capability of the system is better illustrated by the matching throughput rather than the forwarding throughput.

The following results were taken on a set of 13 Pentium-4 2.8 Ghz machines with 1 GB of RAM connected over a 100 Mbps Ethernet network. One machine acts as both publisher and PPS, thus generating the messages, attaching the value-based labels, and forwarding the messages to the appropriate IR nodes. One subscriber node generates 100,000 subscriptions and sends them to the single SPS node. The SPS computes its local tables and subscribes to the appropriate ranges over all attributes implementing the full-match version of the counting algorithm.

The publisher generates 10,000 messages per second with each message carrying a payload of 512 bytes. The payload includes the XML message with varying numbers of attributes; the remainder of the message is padding data. The number of attributes and the traffic patterns are varied to test the system's performance.

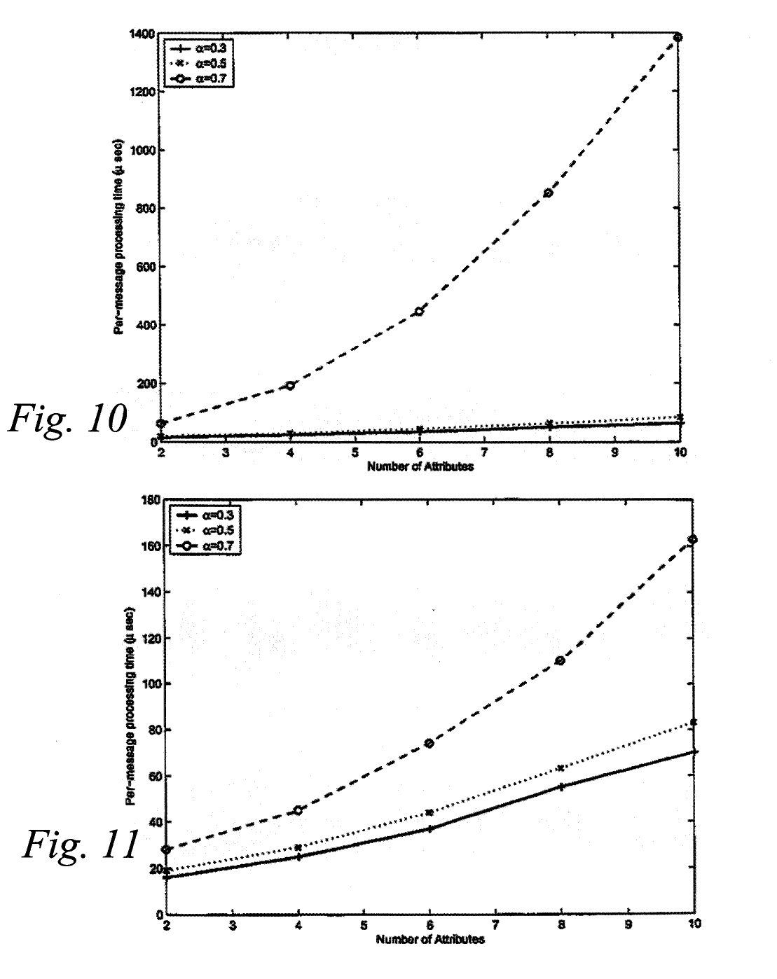

A first experiment generates a stressful workload of subscriptions and publications. For that case, subscriptions and publications were generated using a zipf distribution with same value of α. Furthermore, the same permutation vector was used at both the publisher and the subscriber end to generate the case where the most number of subscriptions are for the most popular events. That results in a message from the range with maximum arrival rate matching a large number of subscriptions, thus resulting in a large number of counter increments. Hence, the performance of the matching unit in that scenario is expected to form a worst case for the corresponding α. The plot of FIG. 10 shows the actual time it takes for the SPS to match and forward all copies of a message from the system for a varying number of attributes and for three different values of α. The following observations can be made. First, in the best case, the SPS needs only 16 μsec per message of matching time. Thus the SPS is able to process not only the 10,000 messages per second generated by the publisher, but has the capacity to scale up to 60,000 messages per second (network permitting). Second, an increasing number of attributes increases the matching time. That increase is caused by the larger number of copies of each message arriving, thus increasing the number of counter increments due to that message. Third, an increase in α results in a super-linear increase in the matching time. As discussed above, that is caused by the choice of having the same values popular both among publishers and subscribers.

A second experiment tests the system in a more general condition. For that experiment, there are different degrees of popularity of various values for subscribers and publishers. The value of α for the publisher is kept at 0.5, while the value of α is changed for subscribers from 0.3 to 0.7. The artificial sharing of popular values is again introduced by the identical permutation vectors so that only the relative interest level in a particular value changes (but the popularity index of a value amongst all values does not). The results of that experiment are shown in FIG. 11. The results show that the message processing times have reduced significantly by changing the interest level in the values. That is true because a message carrying a popular value can now have fewer interested subscriptions, resulting in a lower number of counter increments. This shows that in an average situation, the system of the invention is likely to perform very well.

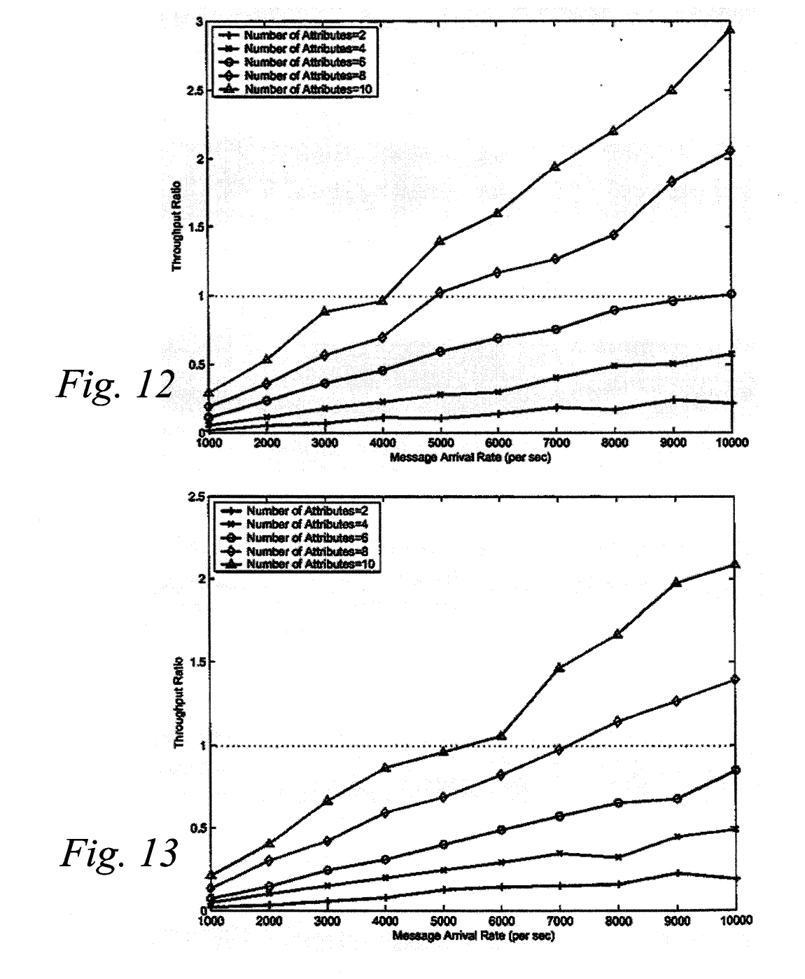

An important measure of the pipelining effect is the amount of throughput the bottleneck node can provide with respect to its input traffic. The experience of the inventors with the system suggests that the bottleneck node is invariably the SPS. The next experiment aims at quantifying the throughput that the SPS can achieve by evaluating its throughput ratio over diverse conditions. α is set to 0.5 for both publisher and subscriber with the same permutation vectors to generate subscriptions and messages having the same values more popular. The plot of FIG. 12 shows the throughput ratio of the SPS with several numbers of attributes in the system, with increasing message arrival rates. As mentioned earlier, a throughput ratio of less than one is mandatory for a node to seamlessly handle its incoming traffic. FIG. 12 shows that while supporting 10 attributes, the system can handle around 4,000 messages per second while serving 100,000 subscriptions. FIG. 13 shows the throughput ratio for the case where the subscription distribution is uniform with the publication distribution having an a of 0.5. In that case, it can be seen that one SPS can support around 5500 messages per second while supporting 10 attributes with 100,000 subscriptions. Those results strongly establish the viability of the present invention in supporting high-rate message streams.

Lastly, the inventors have studied the impact of an increase in the number of subscriptions on the processing time for individual messages. For that experiment, both publication and subscription α were set to 0.5 and both had identical permutation vectors. The results are shown in FIG. 14. There is an almost linear increase in the total message processing time as the number of subscriptions increase. The reason behind that increase is that each new subscription is added to the table corresponding to each of its attributes, thus increasing the number of subscriptions a message matches. However, the data structure at the SPS (with 3-level lookup) ensures that a subscription is only matched against a limited number of messages; i.e., those that match it in some attributes. That is why the increase in per-message processing time is marginal.

Selective Subscription

This set of experiments shows the benefits of the selective subscription mechanism, using simulations. 10,000 subscriptions were considered interested in 5 attributes on an average. There are 50 different attributes in the system each having 10,000 distinct values. The subscriptions ranges for each attribute are chosen independently using the method detailed above. The attributes and values in each message are chosen independently but follow the popularity distribution given by the zipf parameter used for the experiment. Having the subscriptions and messages follow the same distribution yields a high arrival rate at the SPS. There are 20,000 messages arriving per unit time. The parameters that are varied in different simulations are explicitly mentioned below.

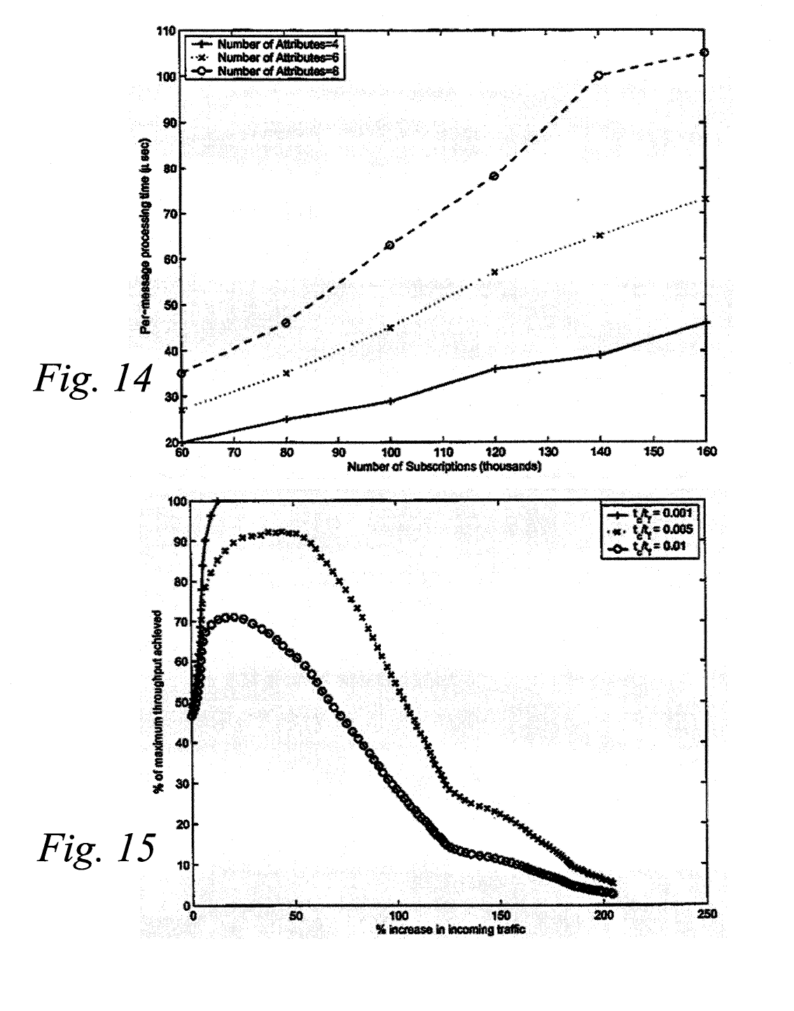

First, the viability of the selective subscription approach is shown with different ratios of time for full-matching (t_{f}) and counter increment (t_{c}). The average t_{f} for matching a message with a subscription is set as 0.0001 units of time. The average range width of each subscription is 30 units. The ratio t_{c}/t_{f} is set to three different values: 0.01, 0.005, and 0.001. The plot of FIG. 15 shows the increase in matching unit throughput in those three cases. Several characteristics of the system are shown by the FIG. 15, as follows. 1) In the base case, when SPS subscribes on only one attribute per subscription, the throughput of the matching unit is low, making it the bottleneck. In the experiment, it is around 45% of the distinct message arrival rate. 2) As the SPS subscribes to more attributes per subscription, the matching unit throughput (and hence the system throughput) increases initially. However, beyond a certain point, the increased cost of counter increments outweighs the gains attained by the reducing number of full-matches. 3) The smaller the ratio t_{c}/t_{f}, the higher the attainable throughput. That is because there is the ability to add extra subscriptions and reduce the number of full-matches without paying much in terms of increased counter maintenance cost. 4) In two of the three cases, the maximum reached throughput is less than 100% of the arrival rate. In the presently described system, that serves as an indication that the SPS is overloaded and some of its subscriptions must be off-loaded to another SPS.

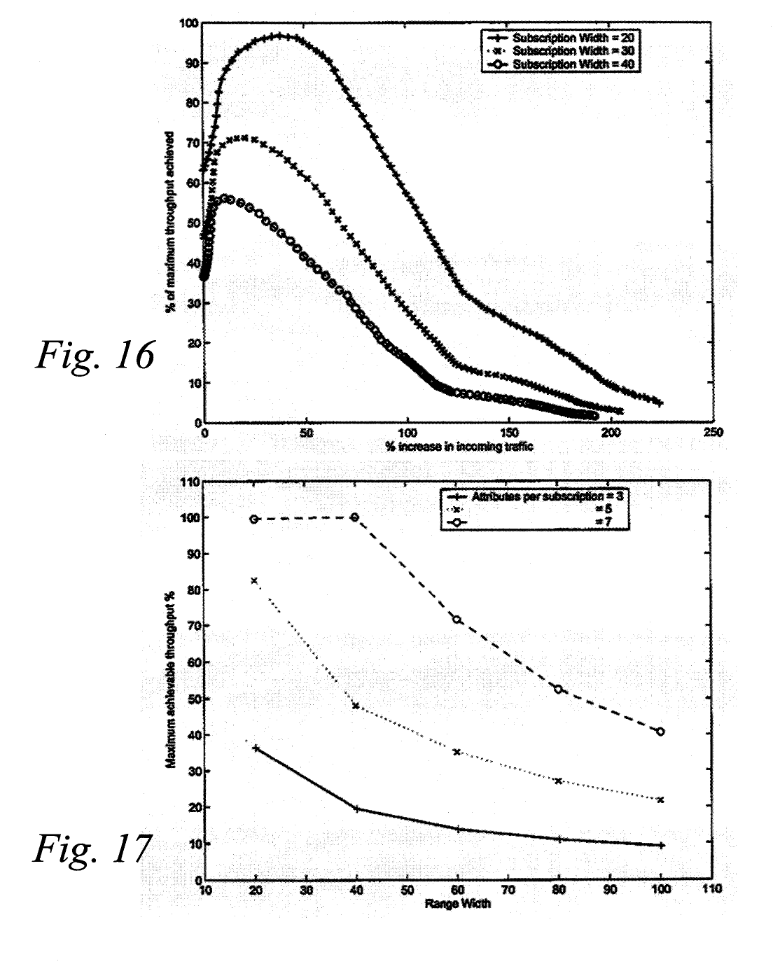

The next experiment shows the impact of different subscription range widths on the attainable throughput. For that experiment, t_{f} is set to 0.0001 time units and the ratio t_{c}/t_{f} is 0.01. FIG. 16 shows the results of that experiment, demonstrating that as the width of the subscriptions increase, the maximum attainable throughput reduces. The reason for that reduction is that the messages matching the new subscription are likely to partially match a larger number of subscriptions. Thus, the cumulative cost of incrementing counters increases faster with wider subscriptions. The same logic also explains the initial throughputs (with 0 extra subscriptions) reducing with the increase in subscription width.

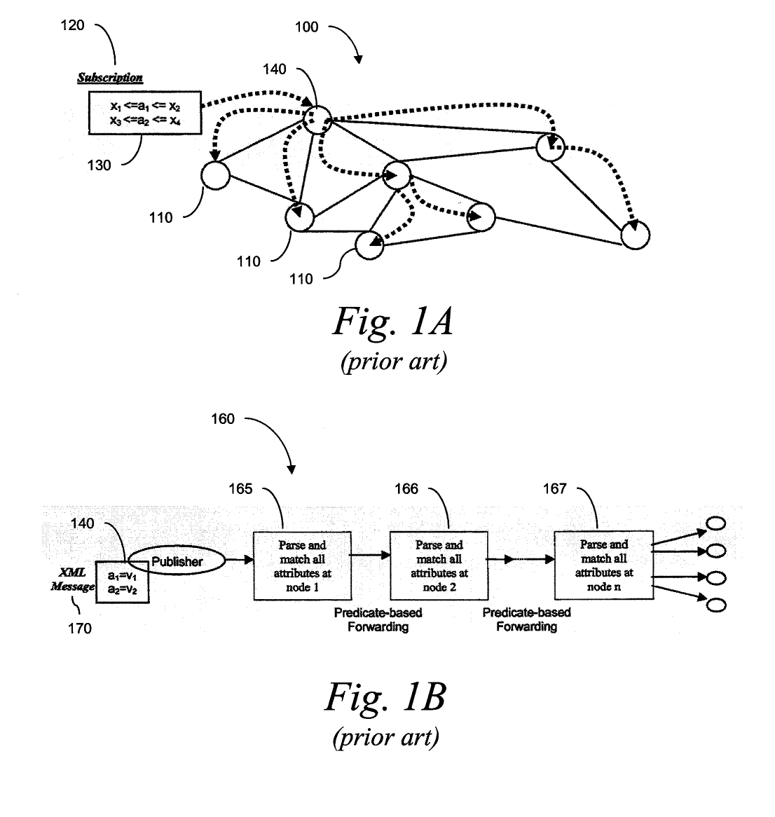

While subscribing to extra attributes could result in a higher matching throughput, it is of interest to know the maximum throughput that attainable. The next experiment aims at identifying the impact of various parameters on the maximum attainable throughput. The ratio t_{c}/t_{f} is set to 0.005, the zipf parameter for subscriptions and publications is set to 0.7, the subscription range width is varied from 20 to 100, the number of attributes on an average per subscription is successively set to 3, 5, and 7. FIG. 17 shows the maximum attainable throughput for several parameters. There are two important observations from that figure. 1) With larger subscription width, the maximum attainable throughput decreases because each additional subscription results in a larger number of potential counter increment operations for the newly added traffic. 2) The larger the number of attributes in a subscription, the larger the possible throughput. That because there are more dimensions to add and improve the throughput.

The foregoing Detailed Description is to be understood as being in every respect illustrative and exemplary, but not restrictive, and the scope of the invention disclosed herein is not to be determined from the Description of the Invention, but rather from the Claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. A method for distribution of a document in a network, the method comprising the steps of:
receiving at an attribute-based forwarding server a message including an attribute and an associated value;
forwarding the message to a root of a value-based forwarding tree, the tree corresponding to the attribute and no other attribute;
from the root, forwarding the message to at least one intermediate router of the value-based forwarding tree corresponding to a first range of values including the value associated with the attribute in the message;
from the at least one intermediate router, forwarding the message to a predicate-based forwarding server corresponding to a second range of values including the value associated with the attribute in the message, the second range being encompassed by the first range; and
at the predicate-based forwarding server, matching the message to a user subscription and forwarding the message to a user.

2. The method of claim 1, further comprising the step of:
parsing the message at the attribute-based forwarding server to identify the attribute.

3. The method of claim 2, further comprising the step of:
attaching to the message at the attribute-based forwarding server a label identifying the value associated with the attribute.

4. The method of claim 3, wherein the label is a pointer to a location of the value in the message.

5. The method of claim 3, wherein the label further contains a unique message ID.

6. The method of claim 1, wherein the message is an XML message.

7. The method of claim 1, further comprising the step of:
from the root or from one of the at least one intermediate routers, forwarding the message to an intermediate router corresponding to a third range of values that does not include the value associated with the attribute in the message.

8. The method of claim 1, further comprising the step of:
dynamically adding an intermediate router between the root and the predicate-based forwarding server.

9. The method of claim 8, wherein the added intermediate router reduces a number of messages forwarded to an intermediate router corresponding to a range of values that does not include a value associated with an attribute in the forwarded message.

10. The method of claim 8, wherein the step of dynamically adding an intermediate router is predicated on a popularity of the value of the attribute.

11. The method of claim 10, further comprising the step of:
determining the popularity of the value by keeping aggregate arrival statistics at an intermediate node.

12. The method of claim 1, wherein the step of matching the message to a user subscription and forwarding the message to a user further comprises the steps of:
determining a total number of attributes associated with the subscription;
counting a number of instances of the message received at the predicate-based forwarding server; and
matching the message to a user subscription when the number of received instances of the message equals the total number of attributes associated with the subscription.

13. The method of claim 1, wherein the step of forwarding the message to a predicate-based forwarding server further comprises the step of:
appending a label to the message including an identification of the forwarding tree.

14. A method for accepting a subscription to receive messages in a content-based network; the method comprising the steps of:
receiving at a subscriber proxy server a plurality of subscriptions, each subscription containing an attribute and a subscription range of values associated with the attribute;
aggregating the subscriptions by determining end points of non-overlapping ranges for the attribute, each non-overlapping range corresponding to a portion of at least one subscription, the end points corresponding to intersections of subscription ranges;
forwarding the end points to a root of an attribute tree corresponding to the attribute and no other attribute;
at the root, determining minimum and maximum values of a union of the end points together with other end points from other subscriber proxy servers; and
forwarding the minimum and maximum values to a predicate-based forwarding server for determining which messages are to be sent to the root.

15. The method of claim 14, further comprising the step of:
storing the attribute and the range of values at the predicate-based forwarding server.

16. The method of claim 14, further comprising the step of:
computing a set of non-overlapping filters for use in forwarding messages from the root to leaf nodes in the attribute tree.

17. The method of claim 16, wherein the step of computing non-overlapping filters comprises optimizing ranges of the filters to minimize a number of sent messages having an attribute value outside an attribute range of a receiving node.

18. The method of claim 14, wherein each subscription contains a plurality of attributes and associated values, and wherein the step of forwarding the end points to a root of an attribute tree is performed for less than all the attributes contained in the subscription.

19. The method of claim 18, further comprising the step of:
determining the attributes and associated values for which the forwarding step is to be performed, based on a degree of filtering benefit provided by the attribute.

20. The method of claim 14, further comprising the step of:
dynamically adding an intermediate router between the root and the predicate-based forwarding server.

21. The method of claim 20, wherein the step of adding an intermediate router results in a reduced a number of messages forwarded to an intermediate router that corresponds to a range of values that does not include a value associated with an attribute in the forwarded message.

22. The method of claim 14, wherein the messages are XML messages.
